(19) United States
(12) Patent Application Publication
(10) Pub. No.: US 2005/0072262 A1
(43) Pub. Date: Apr. 7, 2005

(54) Assembly for securing a cable sheath in a cable release system

(76) Inventors: Danny R. Smith JR., Glen Ellyn, IL (US); Edward S. Dauskurdas, Berwyn, IL (US); Martin J. Roden, Vernon Hills, IL (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 10/676,598

(22) Filed: Oct. 1, 2003

(51) Int. Cl. F16C 1/10

(52) U.S. Cl. 74/502.4

(57) ABSTRACT

The present invention provides an assembly for securing a cable sheath of a cable release system. The assembly includes a mounting bracket, preferably of one-piece construction, which is secured to a sheath of a sheathed cable by a retaining ring rather than by sonic welding or by gluing. Securing the bracket to the sheath by the retaining ring permits free rotation of the cable sheath. The retaining ring will not slide up or down accidentally on the sheath. The retaining ring secures the bracket in place, and also permits adjustment up and down to allow for variations in user assembly requirements.

### BACKGROUND OF THE INVENTION

The invention relates to an assembly for securing a cable sheath in a cable release system. More specifically, the invention relates to a mounting bracket and retaining ring assembly for securing a cable sheath in a cable release system which is used in connection with motion furniture.

In certain pieces of motion furniture, a cable release system is utilized to allow the furniture to move from one position to another, for example, a recliner moving from an upright sitting position to a reclining position. Most cable release systems include a sheathed cable, some means provided at one end of the sheathed cable such that a user of the furniture can manipulate the cable release system to move the furniture from one position to another, a mounting bracket provided proximate to the other end of the sheathed cable, and means for moving the furniture from one position to another attached to the other end of the sheathed cable. The mounting bracket is typically provided in the interior of the furniture. One example of such a cable release system is a D-ring cable release system.

The sheath of the sheathed cable is connected to the mounting bracket, typically by sonic welding and/or gluing. The mounting bracket is then attached to the interior of the furniture by known means. Thus, the sheathed cable is fixed to the frame of the motion furniture. However, with these current methods of securing the sheath to the mounting bracket, several assembly and installation problems often occur.

One problem that has occurred is that once the mounting bracket is welded and/or glued, the mounting bracket is in a fixed position relative to the cable and sheath of the cable, and the frequent resultant twisting and kinking of the cable either caused the manufacturer of the motion furniture to remove and remount the entire cable release system, or caused the release system to malfunction in the field, resulting in inordinately expensive repair or recall.

Another problem that has occurred is that with welding and/or gluing of the mounting bracket, commonly occurring breakage or slippage due to imperfect weld and/or glue application resulted in costly repair and re-work, up to and including recall of the motion furniture.

Thus, there is a need for an improved structure of securing a cable sheath of a cable release system which overcomes the disadvantages of the prior art securing structures. The present invention provides such a structure of securing a cable sheath of a cable release system. Features and advantages of the present invention will become apparent upon a reading of the attached specification, in combination with a study of the drawings.

### OBJECTS AND SUMMARY OF THE INVENTION

A primary object of the invention is to provide an assembly for securing a cable sheath of a cable release system which overcomes the disadvantages of known structures for securing a cable sheath of a cable release systems.

An object of the invention is to provide an assembly having a mounting bracket and a retaining ring for a cable release system which secures the cable sheath to the mounting bracket.

Another object of the invention is to provide an adjustable and removable retaining ring which secures the mounting bracket in place vertically, but permits desirable free rotation of the bracket horizontally to prevent kinking or twisting of the cable.

Still another object of the invention is to secure the mounting bracket to the sheath by a retaining ring in order to eliminate the frequently occurring and costly problems caused by slippage of the bracket resulting from broken or inadequate weld/glue applications.

Yet another object of the invention is to provide an easily removable retaining ring which enables the mounting bracket to be readjusted before or after assembly, allowing for variations in the manufacturer's final assembly requirements.

Another object of the invention is to provide a retaining ring which allows the end user to install the mounting bracket and retaining ring at any vertical point on the cable to provide greater flexibility than was heretofore available, permitting greater flexibility for the furniture retailer with minimal stock-keeping units needed.

Briefly, and in accordance with the foregoing, the present invention provides an assembly for securing a cable sheath of a cable release system. The assembly includes a mounting bracket, preferably of one-piece construction, which is secured to a sheath of a sheathed cable by a retaining ring rather than by sonic welding or by gluing. Securing the bracket to the sheath by the retaining ring permits free rotation of the cable sheath. The retaining ring will not slide up or down accidentally on the sheath. The retaining ring secures the bracket in place, and also permits adjustment up and down to allow for variations in user assembly requirements.

### BRIEF DESCRIPTION OF THE DRAWINGS

The features of the present invention which are believed to be novel are described in detail hereinbelow. The organization and manner of the structure and operation of the invention, together with further objects and advantages thereof, may best be understood by reference to the following description taken in connection with the accompanying drawings wherein like reference numerals identify like elements in which:

FIG. 1 is a perspective view of an assembly having a mounting bracket and a retaining ring which is used for securing a cable sheath of a cable release system;

FIG. 2 is a top elevational view of the assembly illustrated in FIG. 1 where the cable sheath is secured;

FIG. 3 is a cross-sectional view of the assembly illustrated in FIG. 2 and taken along line 3-3; and

FIG. 4 is a cross-sectional view of the assembly illustrated in FIG. 2 and taken along line 4-4.

### DETAILED DESCRIPTION OF THE ILLUSTRATED EMBODIMENT

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated and described herein.

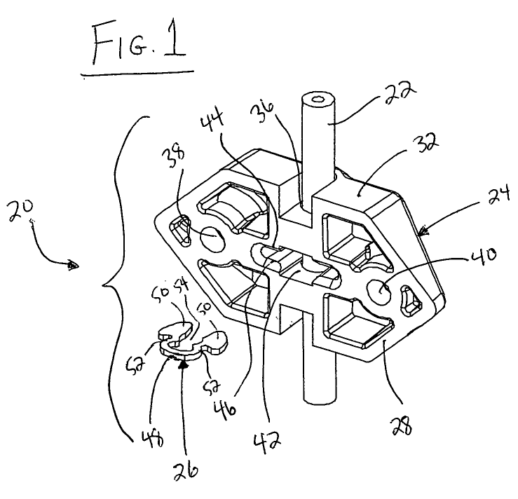

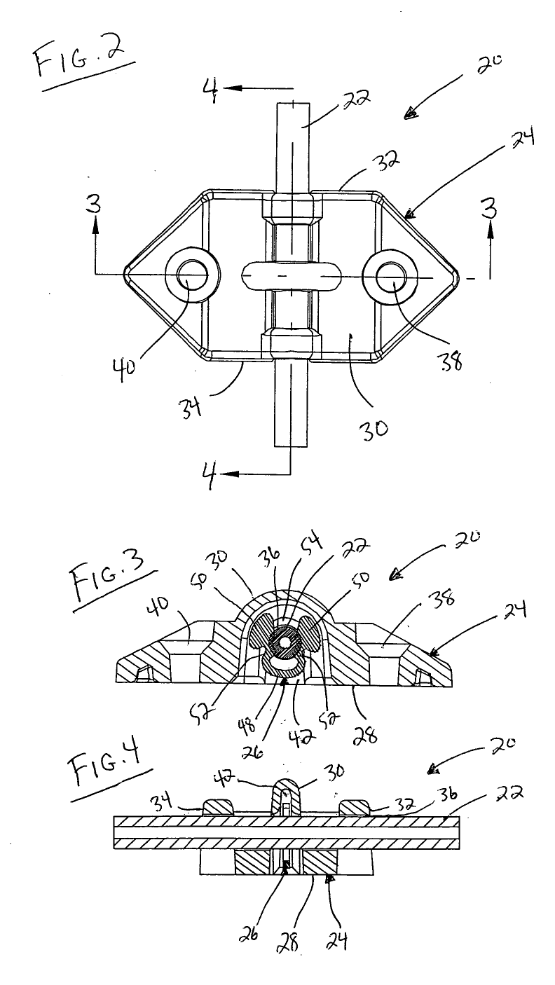

An assembly 20 of a cable release system (not shown) is illustrated in FIGS. 1-4. The assembly 20 is used for securing a cable sheath 22 of the cable release system (not shown). The assembly 20 includes a mounting bracket 24 and a retaining ring 26. The assembly 20 is preferably used in connection with a D-ring cable release system which is used in connection with motion furniture, although it is to be understood that it is equally applicable to other types of cable release systems for use in other products.

The mounting bracket 24 is preferably formed of a one-piece construction and is configured to have a first side surface 28, a second side surface 30, a top surface 32 which connects the first side surface 28 to the second side surface 30, and a bottom surface 34 which connects the first side surface 28 to the second side surface 30.

The first side surface 28 is planar and is preferably configured such that it is positioned against an interior, mounting surface (not shown) of a product (not shown), such as motion furniture. The second side surface 30 can be configured such that it is either planar or non-planar, but it is preferably configured such that it does not interfere with any part of the product in which the cable release system is provided.

The mounting bracket 24 has an aperture 36 which extends through the mounting bracket 24 from the top surface 32 to the bottom surface 34. The aperture 36 must be large enough such that the cable sheath 22 can be positioned therethrough, but must not be large enough such that the cable sheath 22 is allowed to freely move in a lateral position within the aperture 36 of the mounting bracket 24. The aperture 36 is preferably provided in a middle portion of the mounting bracket 24.

The mounting bracket 24 preferably has two apertures 38, 40 which extend through the mounting bracket 24 from the first side surface 28 to the second side surface 30. The aperture 38 is preferably provided on one side of the aperture 36 of the mounting bracket 24, while the aperture 40 is preferably provided on an opposite side of the aperture 36 of the mounting bracket 24. The apertures 38, 40 are provided in the mounting bracket 24 such that the mounting bracket 24 can be secured to the product. The first side surface 28 of the mounting bracket 24 is positioned against the interior mounting surface of the product and fasteners (not shown) are inserted into the apertures 38, 40 from the second side surface 30 of the mounting bracket 24 and secured to the product. The mounting bracket 24 could also be secured to the product by other known means.

The mounting bracket 24 includes a cavity 42 which extends into the mounting bracket 24 from the first side surface 28, but preferably does not extend through the mounting bracket 24 to the second side surface 30. The cavity 42 extends into the mounting bracket 24 and is in communication with the aperture 36 of the mounting bracket 24. The cavity 42 is wider than the aperture 36 such that an upper shoulder 44 is provided by the cavity 42 and such that a lower shoulder 46 is provided by the cavity 42. The purpose for the cavity 42 and the upper and lower shoulders 44, 46 will be discussed further herein.

The mounting bracket 24 may also have further cavities and apertures provided therein or therethrough in order to minimize the amount of material used to form the mounting bracket 24, thus reducing the cost of manufacture of the mounting bracket 24.

The retaining ring 26 is preferably an open-ended spring steel ring which includes a middle section 48, a pair of enlarged end sections 50, and a pair of intermediate sections 52 which interconnect the end sections 50 with the middle section 48. The enlarged end sections 50 are spaced apart from one another to define an opening 54 located opposite the middle section 48. When the retaining ring 26 is in its normal position, the opening 54 is smaller between the enlarged end sections 50 than between the intermediate sections 52. The retaining ring 26 can also be formed in the manner illustrated and described in U.S. Pat. No. 4,886,408.

In operation, the cable sheath 22 is inserted through the aperture 36 of the mounting bracket 24 such that the cable sheath 22 is accessible through the cavity 42 from the first side surface 28 of the mounting bracket 24. The retaining ring 26 is then inserted into the cavity 42 from the first side surface 28 of the mounting bracket 24 such that the enlarged end sections 50 of the retaining ring 26 face the second side surface 30 of the mounting bracket 24. The enlarged end sections 50 are moved against the cable sheath 22 within the cavity 42 between the upper shoulder 44 and the lower shoulder 46. The enlarged end sections 50 are thus moved away from one another and the cable sheath 22 is moved into the opening 54 of the retaining ring 26. The enlarged end sections 50 are then secured to the cable sheath 22.

The retaining ring 26 is thus secured to the cable sheath 22 within the cavity 42 of the mounting bracket 24 between the upper shoulder 44 and the lower shoulder 46, thus completing the assembly 20. The retaining ring 26 permits free rotation of the cable sheath 22. The retaining ring 26 will not slide up or down accidentally on the cable sheath 22 as the retaining ring 26 is prevented from moving too far up or down on the cable sheath 22 because of the confines of the cavity 42 defined by the upper shoulder 44 and the lower shoulder 46. Thus, the retaining ring 26 of the assembly 20 secures the cable sheath 22 in place relative to the mounting bracket 24, but permits adjustment up and down to allow for variations in user assembly requirements of the product.

The retaining ring 26 is adjustable and removable. The retaining ring 26 secures the mounting bracket 24 in place vertically, permitting desirable free rotation of the mounting bracket 24 horizontally to prevent kinking or twisting of the cable sheath 22. The securement of the mounting bracket 24 to the cable sheath 22 by the retaining ring 26 eliminates the frequently occurring and costly problems caused by slippage of the bracket resulting from broken or inadequate weld/glue applications. The easy removability of the retaining ring 26 enables the mounting bracket 24 to be readjusted before or after assembly, allowing for variations in a manufacturer's final assembly requirements. The retaining ring 26 permits the end user to install the assembly 20 at any vertical point on the cable sheath 22 in order to provide greater flexibility than was heretofore available, permitting greater flexibility for the furniture retailer with minimal stock-keeping units needed.

While a preferred embodiment of the present invention is shown and described, it is envisioned that those skilled in the art may devise various modifications of the present invention without departing from the spirit and scope of the appended claims.

1. An assembly for securing a cable sheath in a cable release system of a product, said assembly comprising:
a mounting bracket configured to be secured to the product, said mounting bracket having an aperture therein for receiving the cable sheath; and
means for selectively retaining the cable sheath within said aperture of said mounting bracket, said retaining means configured to permit adjustment of the cable sheath within said aperture of said mounting bracket.

2. An assembly as defined in claim 1, wherein said aperture of said mounting bracket is sized such that the cable sheath is prohibited from freely moving in a lateral position within said aperture of said mounting bracket.

3. An assembly as defined in claim 1, wherein said mounting bracket has a first side surface, a second side surface, and at least one aperture which extends through said mounting bracket from said first side surface to said second side surface, said at least one aperture configured to receive a fastener for securing said mounting bracket to the product.

4. An assembly as defined in claim 3, wherein said first side surface of said mounting bracket is planar and wherein said first side surface of said mounting bracket faces an interior surface of the product for securement of said mounting bracket to the product.

5. An assembly as defined in claim 3, wherein said mounting bracket has a cavity which extends into said mounting bracket from one of said first and second side surfaces, said cavity being in communication with said aperture of said mounting bracket.

6. An assembly as defined in claim 5, wherein said cavity extends into said mounting bracket from said first side surface.

7. An assembly as defined in claim 5, wherein said cavity of said mounting bracket is wider than said aperture of said mounting bracket such that said cavity defines an upper shoulder and a lower shoulder.

8. An assembly as defined in claim 7, wherein said retaining means is configured to be inserted into said aperture of said mounting bracket through said cavity in order to retain said cable sheath within said aperture of said cable sheath, said retaining means being bounded within said cavity by said upper shoulder and said lower shoulder such that movement of said cable sheath within said aperture is bounded by movement of said retaining means.

9. An assembly as defined in claim 8, wherein said retaining means is a retaining ring.

10. An assembly as defined in claim 9, wherein said retaining ring is formed of spring steel.

11. An assembly as defined in claim 9, wherein said retaining ring includes a middle section, a pair of enlarged end sections, and a pair of intermediate sections which interconnect said enlarged end sections with said middle section, said enlarged end portions being spaced from one another to define an opening located opposite said middle section, said opening being configured to accept the cable sheath.

12. An assembly as defined in claim 9, wherein said retaining ring is configured to be adjustable and removable.

13. An assembly as defined in claim 1, wherein said retaining means is a retaining ring.

14. An assembly as defined in claim 13, wherein said retaining ring is formed of spring steel.

15. An assembly as defined in claim 13, wherein said retaining ring includes a middle section, a pair of enlarged end sections, and a pair of intermediate sections which interconnect said enlarged end sections with said middle section, said enlarged end portions being spaced from one another to define an opening located opposite said middle section, said opening being configured to accept the cable sheath.

16. An assembly as defined in claim 13, wherein said retaining ring is configured to be adjustable and removable.

17. An assembly in a cable release system of a product, said assembly comprising:
a cable sheath;
means for mounting said cable sheath to the product; and
means for retaining said cable sheath within said mounting means, said retaining means configured to permit free rotation of said cable sheath within said mounting means.
